(19) United States
(12) Patent Application Publication
(10) Pub. No.: US 2025/0322087 A1
(43) Pub. Date: Oct. 16, 2025

(54) CHUNK TRACEABILITY AND USER-BASED ACCESS CONTROL IN HORIZONTAL RETRIEVAL AUGMENTED GENERATION

(71) Applicant: Cisco Technology, Inc., San Jose, CA (US)

(72) Inventors: Arash Salarian, Chardonne (CH); Marcelo Yannuzzi, Nuvilly (CH); Jean Andrei Diaconu, Gaillard (FR); Hervé Muyal, Gland (CH)

(73) Assignee: Cisco Technology, Inc., San Jose, CA (US)

(21) Appl. No.: 18/931,467

(22) Filed: Oct. 30, 2024

Related U.S. Application Data
(60) Provisional application No. 63/633,436, filed on Apr. 12, 2024.

(51) Int. Cl. G06F 21/62; G06F 40/40

(52) U.S. Cl. CPC G06F 21/6209; G06F 40/40

(57) ABSTRACT

In one implementation, a device may maintain access permissions that control whether a user is allowed to access a particular document. The device may match a plurality of document chunks from a retrieval augmented generation system to a prompt issued by the user for input to a language model. The device may form, based on the access permissions, a modified set of document chunks by excluding a particular document chunk from the plurality of document chunks based on the particular document chunk having a data lineage from the particular document. The device may augment the prompt using the modified set of document chunks prior to input to the language model.

### RELATED APPLICATION

This application claims priority to U.S. Prov. Appl. Ser. No. 63/633,436, filed Apr. 12, 2024, for CHUNK TRACEABILITY AND USER-BASED ACCESS CONTROL IN HORIZONTAL RETRIEVAL AUGMENTED GENERATION SYSTEMS, by Salarian, et al., the contents of which are incorporated herein by reference.

### TECHNICAL FIELD

The present disclosure relates generally to chunk traceability and user-based access control in horizontal retrieval augmented generation (RAG) systems.

### BACKGROUND

Retrieval Augmented Generation (RAG) is a common technique used to avoid hallucinations and enhance the output of Large Language Model (LLMs). Such enhancements are obtained by dynamically adding contextual information to the users' prompt. This is usually done by retrieving contextual information from a vector database, which was previously fed with the relevant information.

Today, many organizations are deploying a horizontal RAG system across their entire organization. Although this model is simple and cost-efficient, it has several drawbacks. For instance, if a horizontal RAG system is fed with documents that are specifically relevant to one department (e.g., finance), other departments may not have rightful access to those documents and those documents should not be accessible to users in the other departments (e.g., sales department, engineering department, etc.). However, existing similarity search techniques are oblivious to the access rights of a given user. Hence, the combination of various chunks during a context retrieval process might end up giving a user access to documents that the user was not originally entitled to access.

As a result, existing horizontal RAG systems are quite “vanilla” in that they are fed with generic documents that every internal user should have access to, and hence lack the data sets that are relevant and specific for each department. There are simply no existing mechanisms to overcome the challenge of controlling the access to specific chunks in horizontal RAG systems. Consequently, the functionality and value of existing horizontal RAG systems are significantly limited.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a system within which chunk traceability and user-based access control may be implemented;

FIG. 4 illustrates an example of a system including chunk traceability and user-based access control implemented in a horizontal RAG system;

FIG. 5 illustrates an example of chunk embeddings resulting from chunk traceability and user-based access control in a horizontal RAG system;

FIGS. 6A-6B illustrate examples of chunk level processing associated with chunk traceability and user-based access control in a horizontal RAG system;

FIG. 7 illustrates an example of a process 700 during inference associated with chunk traceability and user-based access control in a horizontal RAG system; and

FIG. 8 illustrates an example simplified procedure for chunk traceability and user-based access control in horizontal retrieval augmented generation systems, in accordance with one or more implementations described herein.

### DESCRIPTION OF EXAMPLE IMPLEMENTATIONS

### Overview

According to one or more implementations of the disclosure, a device may maintain access permissions that control whether a user is allowed to access a particular document. The device may match a plurality of document chunks from a retrieval augmented generation system to a prompt issued by the user for input to a language model. The device may form, based on the access permissions, a modified set of document chunks by excluding a particular document chunk from the plurality of document chunks based on the particular document chunk having a data lineage from the particular document. The device may augment the prompt using the modified set of document chunks prior to input to the language model.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad- Hoc Network (MANET) is a kind of wireless ad-hoc network, which is generally considered a self-configuring network of mobile routers (and associated hosts) connected by wireless links, the union of which forms an arbitrary topology.

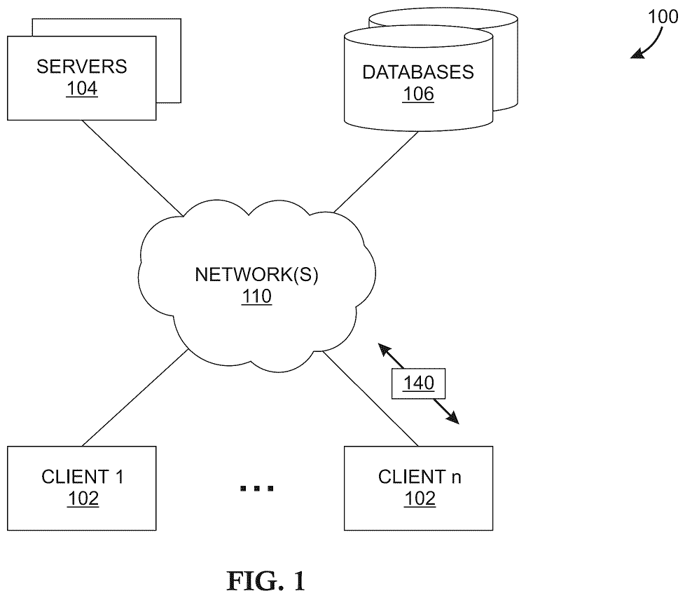

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

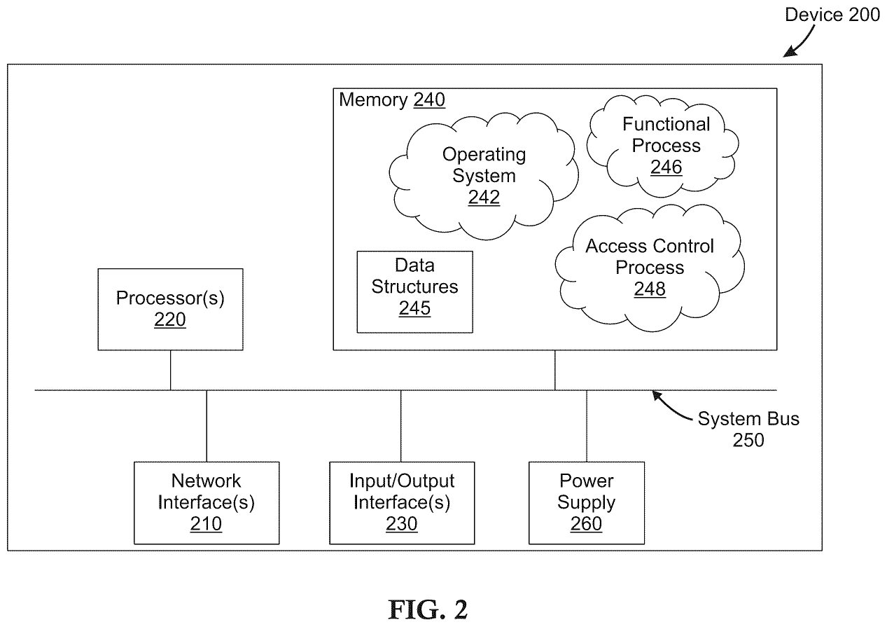

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an access control process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, access control process 248 may include computer executable instructions that, when executed by processor 220, cause device 200 to perform the techniques described herein. To do so, in some implementations, access control process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, access control process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that access control process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, access control process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of configuring an observability platform to perform certain application analytics, access control process 248 may use a generative model to generate configurations based on a conversational input from a user (e.g., voice, text, etc.). Example generative approaches can include, but are not limited to, generative adversarial networks (GANs), large language models (LLMs), other transformer models, and the like.

As noted above, retrieval augmented generation (RAG) is a common design pattern used to avoid hallucinations and enhance the output of large language model (LLMs). In general, the more specific the documentation available in a RAG system, the more value is obtained from it. Hence, a common problem for enterprises is the tradeoff between the cost of implementing and maintaining dedicated RAG systems with specific data per department (e.g., one RAG system for HR, another for sales, etc.) and the more cost-efficient approach of supporting a horizontal RAG system across the entire organization.

Today, many organizations are implementing this second model, where a horizontal RAG system is set up by the IT department, while the users of such system may belong to different units or departments within the organization. Although this model is simple and cost-efficient, if a horizontal RAG system is fed with documents that are specifically relevant to one department (e.g., finance), then some of those documents should not be accessible to users in the sales or engineering departments. In practice, a user would typically have rightful access only to a subset of the documents that comprise a horizontal RAG system.

However, existing similarity search techniques are usually oblivious to the access rights of a given user. Hence, the combination of various chunks during a context retrieval process might end up giving access to documents that the user was not originally entitled to access.

As a result, existing horizontal RAG systems remain functionally limited by virtue of being fed with only generic documents that every internal user should have access to, and hence lack the data sets that are relevant and specific for each department. The reason for this is that controlling the access to specific chunks in horizontal RAG systems remains an unresolved challenge, impacting the value obtained from existing horizontal RAG systems.

### Chunk Traceability and User-Based Access Control in Horizontal Retrieval Augmented Generation

In contrast, the techniques described herein introduce a RAG technique enabling new lineage, dynamic traceability, and user-based access control at chunk level. The techniques described herein may enable enterprises to leverage the efficiencies of using a horizontal RAG system, while retaining control on user access rights at the granularity of document chunks.

Illustratively, the techniques described herein may be performed by hardware, software, and/or firmware, such as in accordance with access control process 248, which may include computer executable instructions executed by the processor 220 (or independent processor of interfaces 210) to perform functions relating to the techniques described herein.

Specifically, according to various implementations, a device may maintain access permissions that control whether a user is allowed to access a particular document. The device may match a plurality of document chunks from a retrieval augmented generation system to a prompt issued by the user for input to a language model. The device may form, based on the access permissions, a modified set of document chunks by excluding a particular document chunk from the plurality of document chunks based on the particular document chunk having a data lineage from the particular document. The device may augment the prompt using the modified set of document chunks prior to input to the language model.

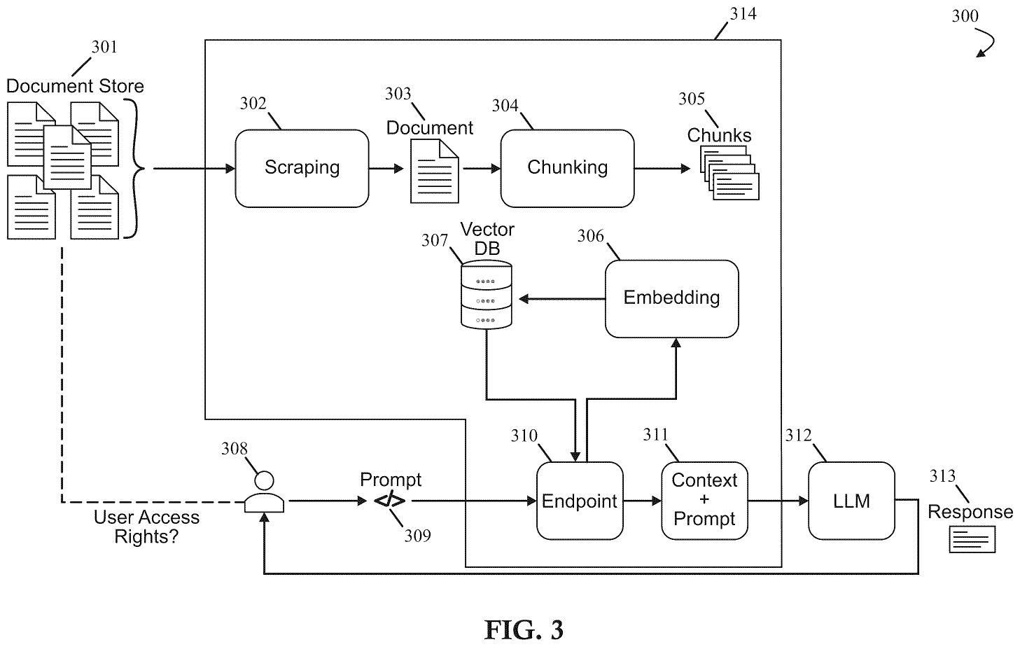

Operationally, FIG. 3 illustrates an example of a system 300 within which chunk traceability and user-based access control may be implemented, in accordance with one or more implementations described herein. During operation of system 300, the documents in document store 301 may be scanned and ingested using scraping system 302. Each document 303 in document store 301 may be broken down into smaller chunks 305 using a variety of chunking methods 304. An embedder 306 may then take each chunk and convert it into an embedding space. In this space, a chunk of text may be represented by a vector of real numbers with a given fixed size. These embeddings may in turn be stored in a vector database 307.

When a user 308 sends a prompt 309 to an endpoint 310, such as a gateway, an inference system, a backend linked to a chatbot interface, and/or another element that may be part of system 300, the input prompt is typically converted to an embedding. Such embedding may be used to search for the most similar chunk embeddings in vector database 307 and retrieve the corresponding (e.g., top k) matches. By using a plurality of methods, one or more chunks may be then selected and concatenated as context to the user prompt in 311. Finally, this combined input (i.e., prompt plus context) may be passed to an LLM 312 to produce the response 313. The main elements that comprise a horizontal RAG system 314 are captured in, where the term “horizontal” indicates that the RAG functionality is used across the organization, and therefore, applies to prompts sourced by users (e.g., user 308) that may belong to different departments.

A key problem with RAG system 314 is that both the insertion of data into vector database 307 as well as the context retrieval process are oblivious to the access rights that user 308 may have on each of the documents that compose document store 301. More specifically, various users, such as user 308, may have rightful access to read and use only a subset of the documents in document store 301, and clearly, any two users might have access to different document sets depending on the users' profile and internal affiliation (e.g., whether they are part of the sales, HR, or finance).

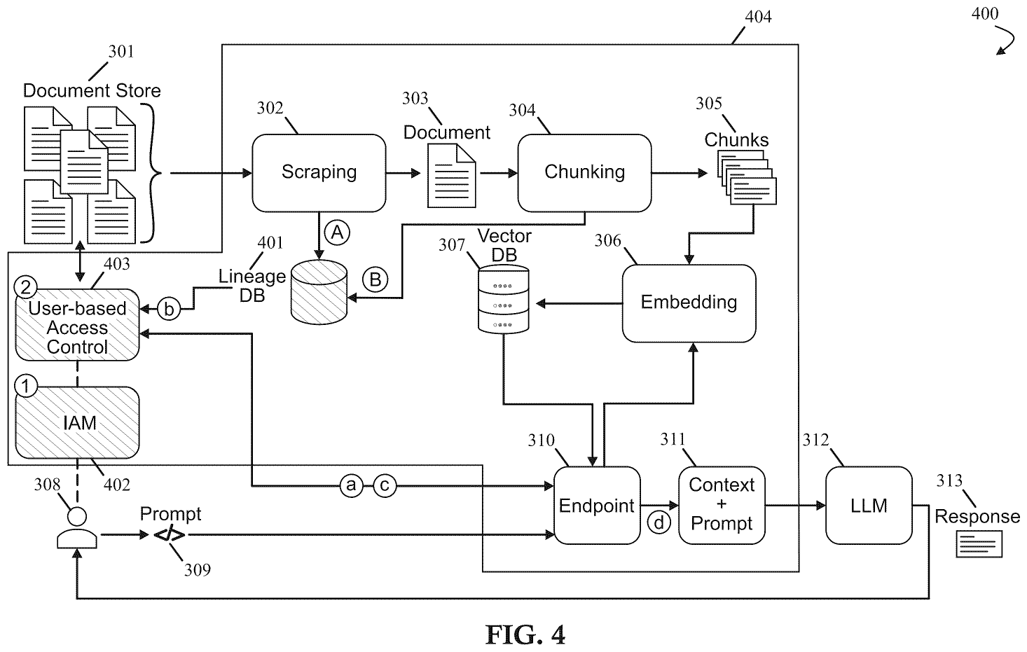

Operationally, FIG. 4 illustrates an example of a system 400 including chunk traceability and user-based access control implemented in a horizontal RAG system 404, in accordance with one or more implementations described herein. That is, elements for chunk traceability and user-based access controls, their interplay, and/or how they might be utilized as part of a horizontal RAG system 404 are illustrated.

As before, the documents in document store 301 may be scanned and ingested using scraping system 302. Since the access rights of a user 308 to a chunk of text within smaller chunks 305 will be determined by the access rights of user 308 to the original document in document store 301, the elements introduced in FIG. 4 may solve for the following lineage and binding problems: chunk_ID-->original_document_ID-->user_ID_access_right to original_document_ID.

To this end, scraping system 302 may keep track of every document ingested and its original source, including the assignment of an ID to each document 303 (e.g., an original_document_ID). This information may be persisted in lineage database 401 in step (A). Subsequently, and as described in FIG. 3, each document 303 in document store 301 may be broken down into smaller chunks 305 using a variety of chunking methods 304. An embedder 306 may then take each chunk and convert it into an embedding, which in turn, may be stored in vector database 307 jointly with their corresponding chunk_IDs. Indeed, such identifiers (i.e., the chunk_IDs) could also be stored in lineage database 401 in step (B).

Hence, lineage database 401 may support the binding of a chunk_ID to an original_document_ID, i.e., chunk_ID-->original_document_ID, thereby enabling to trace the lineage of chunks to their original sources.

Once this horizontal RAG system 404 is configured and prepared to start receiving prompts, user 308 may be initially requested to go through an Identity and Access Management (IAM) process (e.g., IAM process 402). This may occur even before user 308 sends the first prompt through system 400 (see step (1) in FIG. 4).

In one embodiment, the IAM process 402 may be used jointly with a user-based access control method 403, which may extract the identity of user 308 and proactively check its access rights on document store 301 (see step (2) in FIG. 4). More specifically, user-based access control method 403 may identify the documents from document store 301 for which user 308 has rightful access to (e.g., at least read access). This verification may take place at identification and/or authentication (AuthN) time, or immediately after, and may also be performed before the user even enters the first prompt (e.g., prompt 309) in system 400. Moreover, the result of such verification may be persisted by user-based access control method 403.

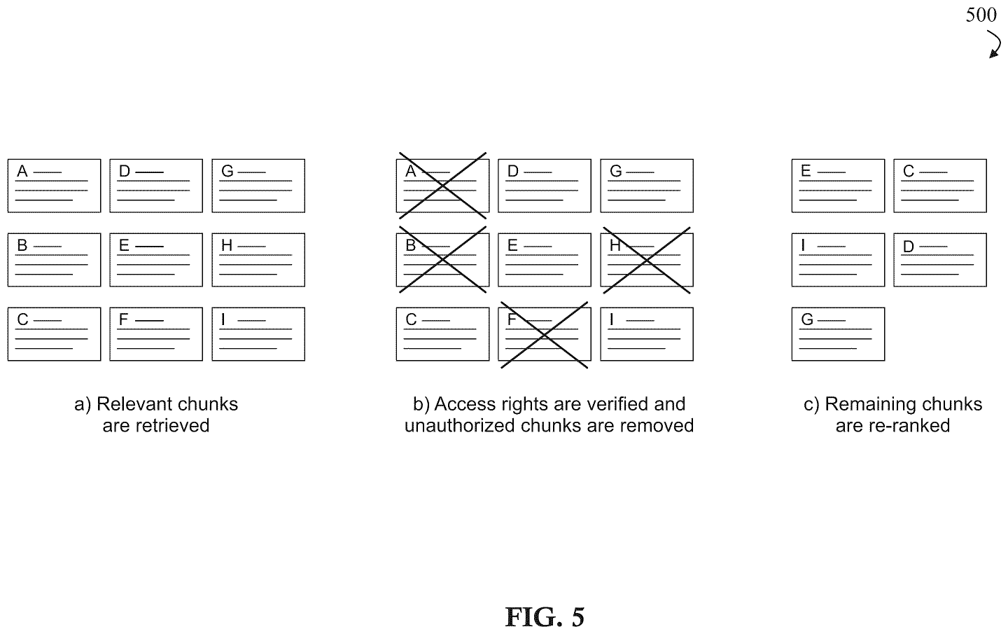

Hence, steps (1) and (2) in FIG. 4 support the dynamic identification, proactive binding, and persistence of the access rights that a user_ID has over the specific set of documents that compose document store 301. In other words, for each document ID vectorized in the RAG, user-based access control method 403 may be able to solve for the binding: original_document_ID-->user_ID_access_right to original_document_ID. Thus, when an authenticated user (e.g., user 308) sends a prompt 309 to endpoint 310, the prompt may follow a standard RAG flow and be converted to an embedding using embedder 306 in FIG. 3. Such embedding may be used to search for, and retrieve, the most similar chunk embeddings from vector database 307. An example of such chunks is depicted in group a) in FIG. 5. These chunks along with their corresponding chunk_IDs may now be parsed and processed by endpoint 310 as follows (see steps (a)-(d) in FIG. 4):
(a) The user_ID associated to the user that sent prompt 309 may be available to endpoint 310, along with the chunk_IDs obtained from vector database 307. This information may now be used as a new input and sent to user-based access control method 403.
(b) The input received by user-based access control method 403 in step (a) may be used by this latter to obtain the lineage of those chunk_IDs from lineage database 401, and verify the access rights associated to an already authenticated user_ID, thereby enabling to solve for the binding: chunk_ID-->original_document_ID-->user_ID_access_right to original_document_ID.
(c) The result of step (b) may be returned to endpoint 310, which may be used to remove the chunks that the user is unauthorized to access (see group b) in FIG. 5. The set of remaining chunks may be re-ranked, and the top relevant ones may be selected (see group c) in FIG. 5). In one embodiment, a secondary embedding (distinct from the initial embedding from embedder 306) may be used at this stage for re-ranking.
(d) The selected chunks may be concatenated as context to the user prompt in 311 and passed to an LLM 312 to produce the response 313.

FIG. 5 illustrates an example of chunk embeddings 500 resulting from chunk traceability and user-based access control in a horizontal RAG system, in accordance with one or more implementations described herein. The chunk embeddings 500 may be organized according to a retrieve, filter, and/or re-rank paradigm. For example, group a) may correspond to relevant chunks retrieved from a vector database. Group b) may correspond to the remaining chunks after access rights are verified and unauthorized chunks are removed. Group c) may correspond to re-ranked remaining chunks.

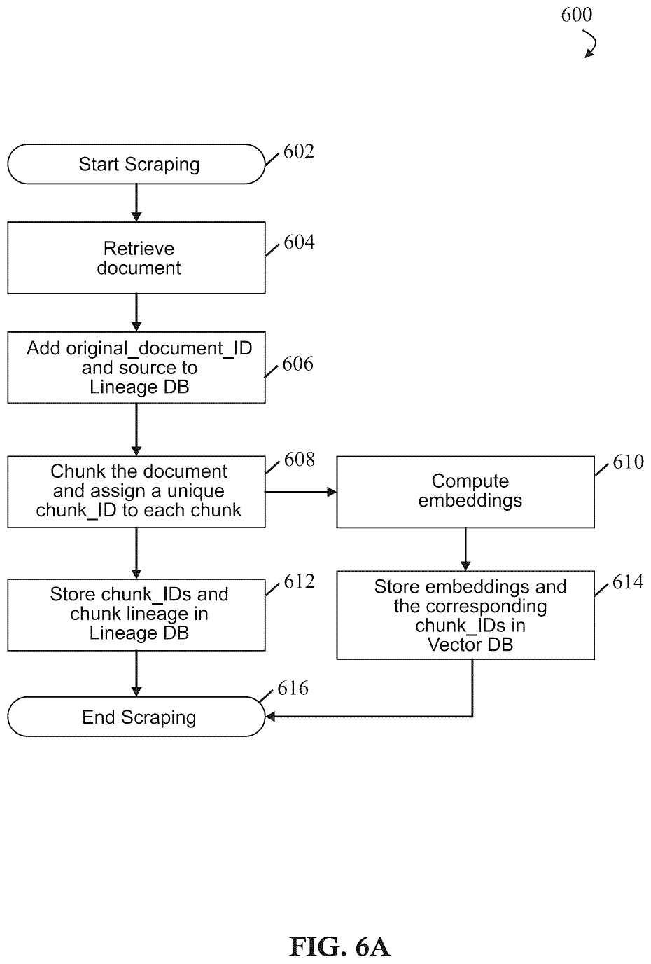

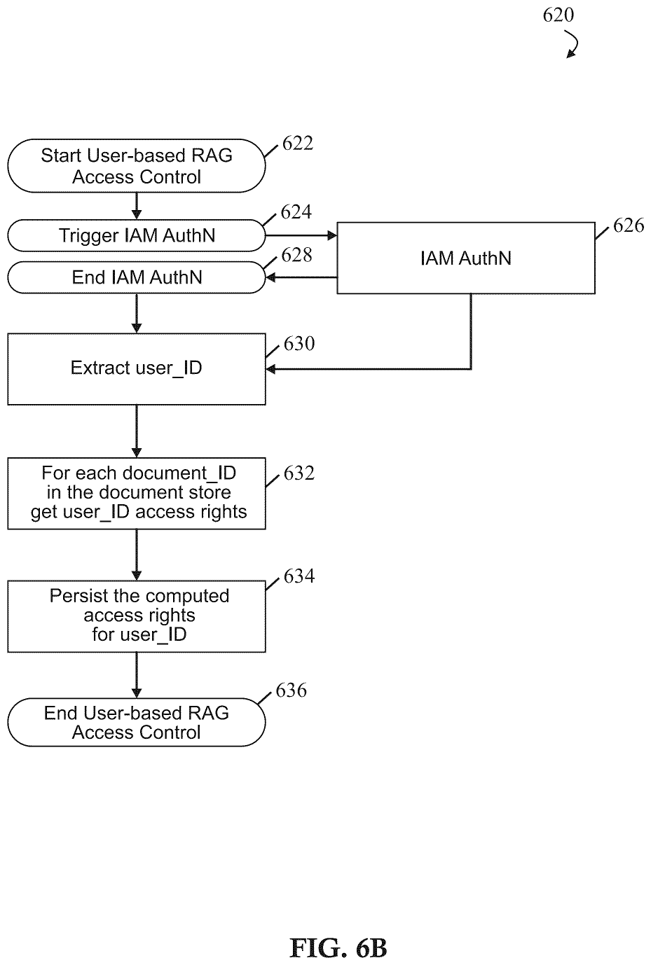

FIGS. 6A-6B illustrate examples of chunk level processing associated with chunk traceability and user-based access control in a horizontal RAG system, in accordance with one or more implementations described herein. More specifically, FIG. 6A illustrates a scraping and lineage process 600 at chunk level. As shown, process 600 may start at step 602 and continue to step 604, where the device may retrieve a document.

At step 606, the device adds the identifier (original_document_ID) for the original document retrieved at step 604 to the lineage database, as well as information indicative of the source of the document.

At step 608, the device then forms chunks from the document and assigns each of those chunks a unique chunk identifier (chunk_ID). The device at step 612 then stores those chunk identifiers and their corresponding chunk lineage information in the lineage database.

At step 610, the device also computes embeddings for the chunks and, at step 614, stores those embeddings and corresponding chunk identifiers in the vector database.

Procedure 600 then ends at step 616. Thus, process 600 summarizes the scraping and lineage at the chunk level for later use.

In various implementations, the process 620 depicted in FIG. 6B may create the initial binding of: original_document_ID→user_ID_access_right to original_document_ID. More specifically, process 620 may start at step 622 and continue on to step 624 where the device triggers an IAM Authorization. The device then determines at step 626 whether the user is authorized. If not, the device may end the processing at step 628. Otherwise, if the user is authorized, the device may extract their user identifier (user_ID) at step 630. In turn, the device may get the access rights for that user identifier for each document identifier in the document store, at step 632. The device then persists the computed access rights for that user identifier at step 634 and process 620 ends at step 636.

Note that processes 600 and 620 may initially occur even before the first inference takes place in system 400, and then, they may be applied asynchronously, such as when a new document is inserted in document store 301, or when a user needs to reauthenticate. In addition, a further implementation provides for 620 to be implemented using other triggers besides one leveraging an IAM AuthN flow. The reason for this is that a user's access right to a document may change dynamically, therefore affecting the stored lineage at chunk level. Hence, user entitlements may be recomputed and/or updated using other triggers, including the push of notifications (e.g., when RD permissions change for a document in the store), or pulling user access rights periodically (e.g., even after a user has authenticated).

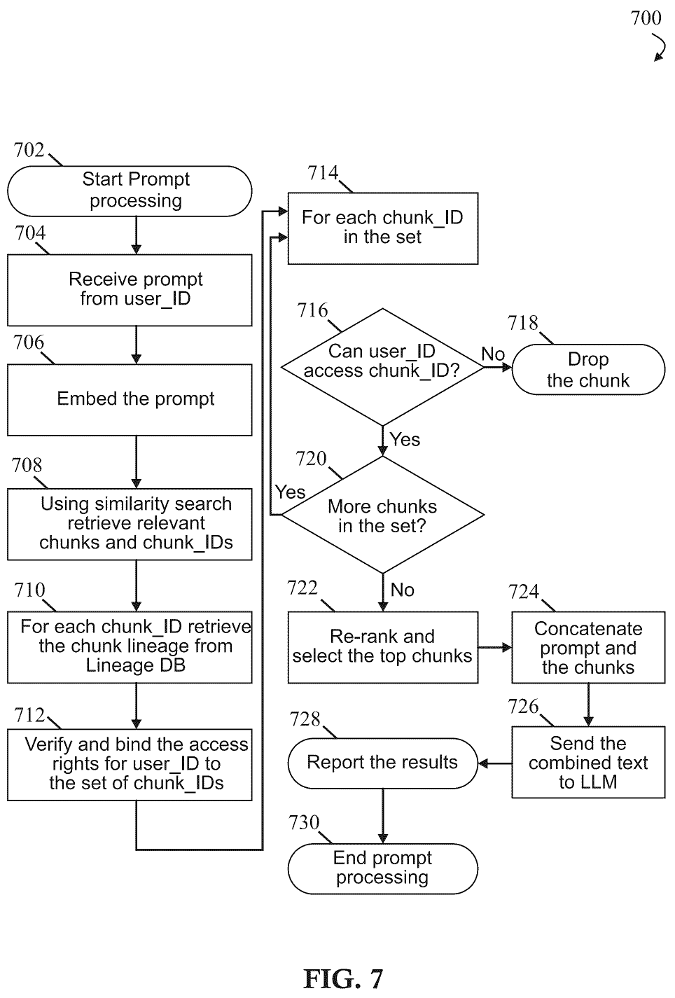

FIG. 7 illustrates an example of a process 700 of the steps taken during inference associated with chunk traceability and user-based access control in a horizontal RAG system, in accordance with one or more implementations described herein. Process 700 summarizes the operation during inference, including steps (a)-(d) in FIG. 4. This may include automatically solving for the second level of binding introduced herein, namely: chunk_ID→original_document_ID→user_ID_access_right to original_document_ID.

More specifically, process 700 may start at step 702 and continue on to step 704 when the user enters a new prompt. In turn, the device embeds the prompt at step 706 and performs a similarity search in the RAG to retrieve the relevant chunks and chunk identifiers, at step 708.

In various implementations, at step 710, the device retrieves the chunk lineage from the chunk database for each chunk identifier identified in step 708. The device then, at step 712, verifies and binds the access rights for the user (based on their identifier) to the set of chunk identifiers.

For each chunk identifier in the set, the device then initiates an iterative processing at step 714. During this iterative processing, the device at step 716 determines whether the user identifier is allowed access to a particular chunk. If not, at step 718, the device drops the chunk from the output. This iterative process, at step 720, then continues if there are any chunks left in the set to assess.

Once the iterative evaluation of the chunk access rights is complete, at step 722, the device re-ranks the remaining chunks and selects the top n-number of them. At step 724, the device then concatenates the prompt and the chunks and, at step 726, sends the combined text to the LLM.

In some implementations, at step 728, the device then reports the results to the user and ends its prompt processing at step 730.

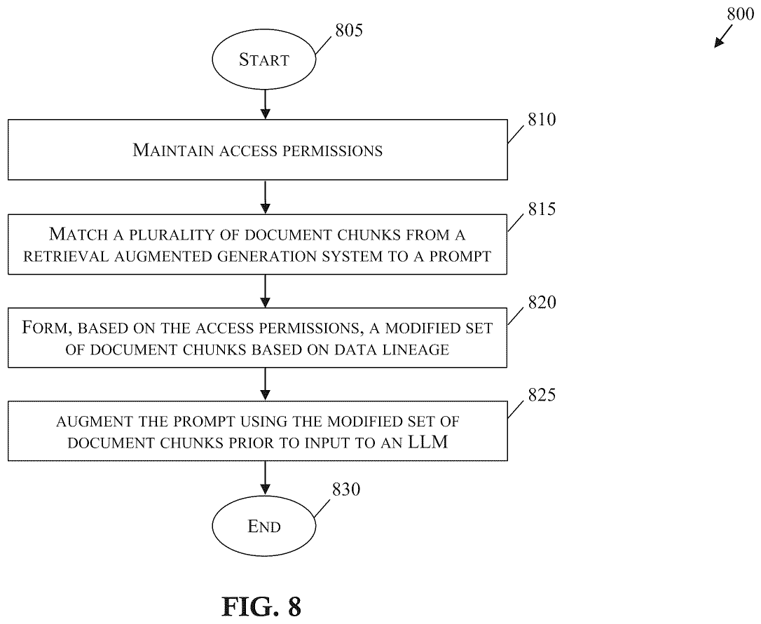

FIG. 8 illustrates an example simplified procedure for chunk traceability and user-based access control in horizontal retrieval augmented generation systems, in accordance with one or more implementations described herein. For example, a non-generic, specifically configured device (e.g., device 200), may perform procedure 800 (e.g., a method) by executing stored instructions (e.g., access control process 248).

The procedure 800 may start at step 805, and continues to step 810, where, as described in greater detail above, the device (e.g., a controller, processor, etc.) may maintain access permissions that control whether a user is allowed to access a particular document. The access permissions may be maintained utilizing a user identity-based access control system. The access permissions may include a listing of access permissions for a specific user or class of users.

These permissions may be permissions utilized to prevent the user from accessing particular documents which may be held within a document store and/or ingested into/stored within a RAG system. In some implementations, these access controls may be borrowed from and/or shared with an existing document access system or purpose. For instance, the access controls may include user identity and particular document access permissions that are utilized to control document access within other aspects of an enterprise besides just LLM utilization. For example, documents in a document store may be accessed for other purposes, but their access controls may not need to be managed separately from the access controls for those documents as they related to the RAG system utilization.

In various implementations, these access permissions may be dynamic. That is, individual or groups of user permissions to particular documents may be changed, the contents of stored/available documents may be changed, the actual documents stored/available may change, etc. and any of these things may change a user's access permissions. As such, access permissions may be reconciled and/or recomputed periodically and/or in response to events. For example, access permissions may be recomputed responsive to a push notification of a permission change for a document.

At step 815, as detailed above, a device may match a plurality of document chunks from a retrieval augmented generation system to a prompt issued by the user for input to a language model. For example, a prompt may be received from a user associated with a particular user identifier. That prompt may be converted to an embedding and then, using a similarity search, matching document chunks may be identified in vector database and/or the corresponding (e.g., top k) matching chunks may be retrieved.

Each of these document chunks may ultimately be a chunk of text, etc. resulting from a breaking down or chunking of a document in a document store utilizing a chunking methodology. For example, scraping of documents from a document store may be conducted by retrieving a document and adding an original document identifier to the document. The document may be chunked, and each chunk may be assigned a unique chunk identifier.

At step 820, as detailed above, a device may form, based on the access permissions, a modified set of document chunks by excluding a particular document chunk from the plurality of document chunks based on the particular document chunk having a data lineage from the particular document. As outlined above, each document may be associated with an original document identifier and each chunk with a chunk identifier. In various implementations, an association between the chunk identifier and the original document identifier of the document whence it came may establish a data lineage for that chunk back to its originating document. That is, the device may associate a data lineage to each document chunk ingested into the retrieval augmented generation system, wherein that data lineage identifies an originating document for a corresponding document chunk.

In various implementations, a device may maintain a data lineage repository. The repository may store associations between chunk identifiers (e.g., identifying each document chunk ingested into the retrieval augmented generation system) with originating document identifiers (e.g., identifying an originating document for a corresponding document chunk). Then, by referencing the data lineage repository, the data lineage of a particular document chunk may be identified.

Once a lineage is established between a document chunk (e.g., that matches a prompt) and its corresponding originating document, then the access permissions of a user with respect to the originating document may be utilized to infer a permission of the user with respect to that document chunk. As previously mentioned, the access permissions applicable to a user may be identified based on a user authentication process. In such instances, the user may be required to reauthenticate responsive to a new document being ingested into the retrieval augmented generation system in order to ensure that the access permissions accurately reflect current access policies.

The modified set of document chunks may be formed by identifying one or more matching document chunks to which the user (e.g., the identity associated with the submission of the prompt) lacks access based on that chunk originating from a document to which the user lacks access permissions. In various implementations, after excluding unauthorized chunks, the documents in the modified set of document chunks may be reranked prior to the input to the language model.

At step 825, as detailed above, the device may augment the prompt using the modified set of document chunks prior to input to the language model. This may include concatenating a prompt and the remaining and/or re-ranked document chunks in the modified set of document chunks and sending the combination to an LLM. In various implementations, the results of the execution of one or more of the steps of procedure 800 may be reported to a user, an administrator, a RAG control and/or monitoring system, an access control and/or monitoring system, etc. In some instances, which of the plurality of document chunks from the retrieval augmented generation system are included in the modified set of document chunks may be updated based on a change in document access rights associated with the user.

Procedure 800 then ends at step 830.

It should be noted that while certain steps within procedure 800 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduces a RAG technique enabling new lineage, dynamic traceability, and user-based access control at chunk level. The techniques described herein, may enable organizations to benefit from the efficiencies of using a horizontal RAG system, while retaining control on user access rights at the granularity of document chunks.

While there have been shown and described illustrative implementations that provide for horizontal RAG systems, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended 10 claims to cover all such variations and modifications as come within the true spirit and scope of the implementations herein.

What is claimed is:

1. A method, comprising:
maintaining, by a device, access permissions that control whether a user is allowed to access a particular document;
matching, by the device, a plurality of document chunks from a retrieval augmented generation system to a prompt issued by the user for input to a language model;
forming, by the device and based on the access permissions, a modified set of document chunks by excluding a particular document chunk from the plurality of document chunks based on the particular document chunk having a data lineage from the particular document; and
augmenting, by the device, the prompt using the modified set of document chunks prior to input to the language model.

2. The method as in claim 1, further comprising:
reranking documents in the modified set of document chunks prior to the input to the language model.

3. The method as in claim 1, further comprising:
associating a data lineage to each document chunk ingested into the retrieval augmented generation system, wherein that data lineage identifies an originating document for a corresponding document chunk.

4. The method as in claim 1, wherein the access permissions prevent the user from accessing the particular document.

5. The method as in claim 1, further comprising:
maintaining a data lineage repository associating chunk identifiers that identify each document chunk ingested into the retrieval augmented generation system with originating document identifiers that identify an originating document for a corresponding document chunk.

6. The method as in claim 5, further comprising:
referencing the data lineage repository to identify the data lineage of the particular document chunk.

7. The method as in claim 1, further comprising:
updating, based on a change in document access rights associated with the user, which of the plurality of document chunks from the retrieval augmented generation system are included in the modified set of document chunks.

8. The method as in claim 1, further comprising:
identifying the access permissions applicable to the user based on a user authentication process.

9. The method as in claim 8, further comprising:
requiring the user to reauthenticate responsive to a new document being ingested into the retrieval augmented generation system.

10. The method as in claim 1, further comprising:
recomputing the access permissions that control whether a user is allowed to access a particular document responsive to a push notification of a permission change for a document.

11. An apparatus, comprising:
one or more network interfaces;
a processor coupled to the one or more network interfaces and configured to execute one or more processes; and
a memory configured to store a process that is executable by the processor, the process when executed configured to:
maintain access permissions that control whether a user is allowed to access a particular document;
match a plurality of document chunks from a retrieval augmented generation system to a prompt issued by the user for input to a language model;
form, based on the access permissions, a modified set of document chunks by excluding a particular document chunk from the plurality of document chunks based on the particular document chunk having a data lineage from the particular document; and
augment the prompt using the modified set of document chunks prior to input to the language model.

12. The apparatus as in claim 11, wherein the process, when executed, is further configured to:
perform a reranking of documents in the modified set of document chunks prior to the input to the language model.

13. The apparatus as in claim 11, the process when executed further configured to:
associate a data lineage to each document chunk ingested into the retrieval augmented generation system, wherein that data lineage identifies an originating document for a corresponding document chunk.

14. The apparatus as in claim 11, wherein the access permissions prevent the user from accessing the particular document.

15. The apparatus as in claim 11, the process when executed further configured to:
maintain a data lineage repository associating chunk identifiers that identify each document chunk ingested into the retrieval augmented generation system with originating document identifiers that identify an originating document for a corresponding document chunk.

16. The apparatus as in claim 15, the process when executed further configured to:
reference the data lineage repository to identify the data lineage of the particular document chunk.

17. The apparatus as in claim 11, the process when executed further configured to:
update, based on a change in document access rights associated with the user, which of the plurality of document chunks from the retrieval augmented generation system are included in the modified set of document chunks.

18. The apparatus as in claim 11, the process, when executed, is further configured to:
identify the access permissions applicable to the user based on a user authentication process.

19. The apparatus as in claim 18, the process, when executed, is further configured to:
require the user to reauthenticate responsive to a new document being ingested into the retrieval augmented generation system.

20. A tangible, non-transitory, computer-readable medium storing program instructions that cause a device to execute a process comprising:
maintaining access permissions that control whether a user is allowed to access a particular document;
matching a plurality of document chunks from a retrieval augmented generation system to a prompt issued by the user for input to a language model;
forming, based on the access permissions, a modified set of document chunks by excluding a particular document chunk from the plurality of document chunks based on the particular document chunk having a data lineage from the particular document; and
augmenting the prompt using the modified set of document chunks prior to input to the language model.
